(19) United States
(12) Patent Application Publication
(10) Pub. No.: US 2010/0066034 A1
(43) Pub. Date: Mar. 18, 2010

(54) V-ring seal

(75) Inventor: Xiao-Peng Li, Taizhou (CN)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(73) Assignee: ZHEJIANG RONGPENG AIR TOOLS CO., LTD

(21) Appl. No.: 12/458,650

(22) Filed: Jul. 20, 2009

(30) Foreign Application Priority Data
Sep. 17, 2008 (CN) 200820136725.3

(51) Int. Cl. F16J 15/10

(52) U.S. Cl. 277/626

(57) ABSTRACT

A high fracture toughness, wear resistant V-ring seal with superior flexibility, leak tightness and longer operational life comprises an upper V-shaped recess (5), an inner wall (6), an exterior wall (7) and a V-shaped lower surface (9). Said seal is characterized in that an annular groove (8) whose bottom is an open arc is disposed on a bottom of the upper recess (5).

### FIELD OF THE INVENTION

The present invention relates to a V-ring seal, made of fabric reinforced rubber.

### BACKGROUND OF THE INVENTION

As shown in FIG. 1 is a conventional V-ring seal made of leather incorporated in a pumping unit of an electric or airless paint dispersing means. Each V-ring seal (3) is sandwiched by two plastic V-shaped annular frames (4) and stacked upwardly according this fashion, forming a set of gaskets, providing air tightness to the pump.

Since leather doesn't possess sufficient strength to against constant reciprocal movement, said seal (3) made of genuine leather is easily deformed and worn, deformation can also cause crack of the seal (3) from the bottom of upper recess which degrades the air tightness of the pump and operational life of the means.

### SUMMARY OF THE INVENTION

For solving aforementioned problem, a V-ring seal made of fabric reinforced rubber is disclosed in the present invention to replace traditional V-ring made of leather which is easily deformed and worn. By incorporating said claimed seal in a pump of an electric or airless paint dispersing means, lack of air tightness and low operational life are expected to be improved.

A V-ring seal with fabric reinforced layer consists of an upper V-shaped recess (5), an inner wall (6), an exterior wall (7) and a V-shaped lower surface (9).

Said upper V-shaped recess (5) is formed by two annular bevels, each bevel is disposed on an end of an upper portion of the seal.

Said inner wall (6) is an annular bevel whose one end adjoins with an end of an inner flank of said recess (5).

Said exterior wall (7) is an annular bevel whose one end adjoins with an end of a lateral flank of said recess (5).

Said V-shaped lower surface (9) is an arrow-like projection formed by two annular bevels, each bevel is disposed on an end of a lower portion of the seal and one flank thereof attaches with another end of the inner wall (6) and exterior wall (7) respectively.

Said V-ring seal (1) is characterized in that an annular groove (8) is disposed on a bottom of said upper recess (5) where two bevels intersect; a bottom of the groove (8) is in an open arc shape.

Accordingly, said V-ring seal (1) has an integral structure of an annular shape and a sectional structure of a V-shape.

Moreover, said V-ring seal (1) is made of fabric reinforced rubber.

Furthermore, said inner wall (6) may adjoin with said upper recess (5) by a cross point or a transient curve; and said exterior wall (7) may adjoin with said upper recess (5) by a cross point or a transient curve.

Comparing with prior art, the annular groove (8) set on the bottom of the upper recess (5) can bear superior force generated by deformation, avoiding crack of the seal (1). It also provides the seal (1) with better flexibility which improves the air tightness thereof.

### BRIEF DESCRIPTION OF DRAWINGS

FIG. 1 is a sectional view of conventional V-ring assembly made of leather mounted on a plunger.

FIG. 2 is a vertical view of the present invention.

FIG. 3 is a bottom view of the present invention.

FIG. 4 is a cross-sectional view of FIG. 2 along line IV-IV.

FIG. 5 is a sectional view of a V-ring seals assembly mounted on a plunger.

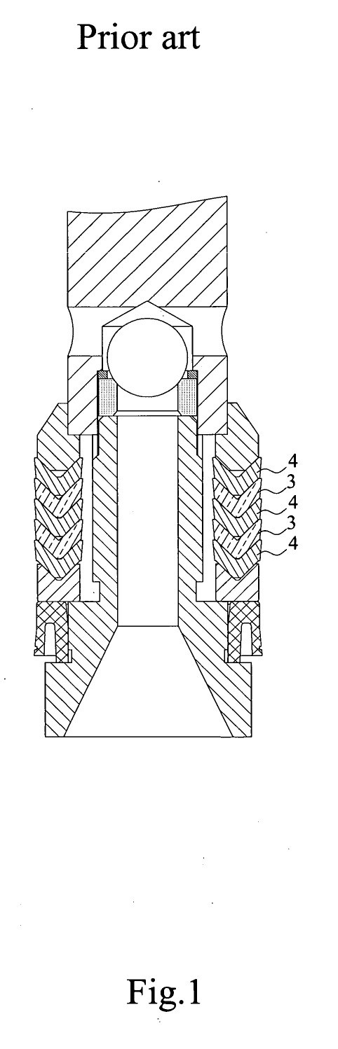

### DETAIL DESCRIPTION OF PREFERRED EMBODIMENTS

Description of embodiment of the present invention is described in detail according to the appended drawings hereinafter.

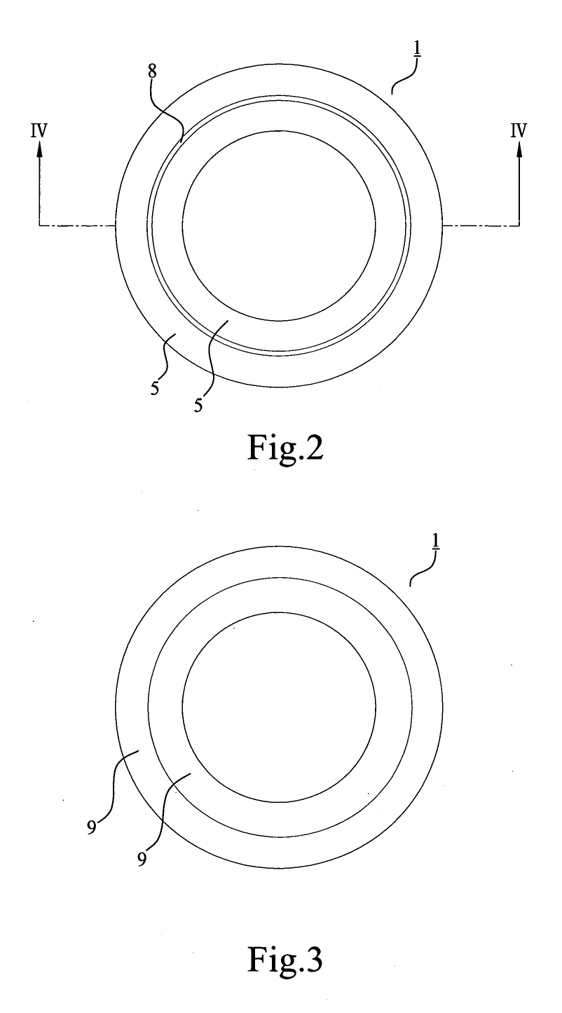

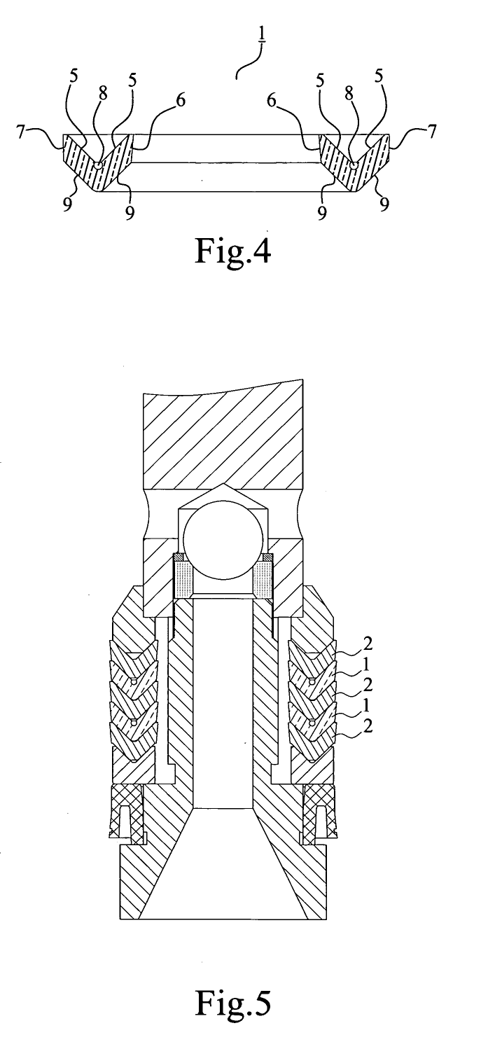

As illustrated in FIGS. 2-5, a V-ring seal (1) claimed in the present invention consists of an upper V-shaped recess (5), an inner wall (6), an exterior wall (7) and a V-shaped lower surface (9).

Said upper V-shaped recess (5) is formed by two annular bevels, each bevel is disposed on an end of an upper portion of the seal.

Said inner wall (6) is an annular bevel whose one end adjoins with an end of an inner flank of said recess (5).

Said exterior wall (7) is an annular bevel whose one end adjoins with an end of a lateral flank of said recess (5).

Said V-shaped lower surface (9) is formed by two annular bevels, each bevel is disposed on an end of a lower portion of the seal and one flank thereof attaches with another end of the inner wall (6) and exterior wall (7) respectively.

Said V-ring seal (1) is characterized in that an annular groove (8) is disposed on a bottom of said upper recess (5) where two bevels intersect. The bottom of the groove (8) is in an open arc shape.

By having an open type arc shaped groove (8), the V-ring seal (1) is provided with high flexibility and tension which improve the air tightness of the seal (1) and it also prolongs the operational life thereof.

Accordingly, said V-ring seal (1) has an integral structure of an annular shape and a sectional structure thereof is a V-shaped. Said structure is well known by a person who having ordinary skill in the art, therefore, no detail is described herewith.

Moreover, said V-ring seal (1) is made of fabric reinforced rubber. A cloth insertion is inserted within the exterior, intermediate or interior layer of the rubber for strengthening the seal and to avoid the wear. The material of said fabric insertion is variable depending different working condition.

Furthermore, said inner wall (6) may adjoin with said upper recess (5) by a sharp edge or a transient curve; and said exterior wall (7) may also adjoin with said upper recess (5) by a sharp edge or a transient curve. A sharp edge can provide maximum air tightness while a transient curved flank can protect the cylindrical wall of the pump and extend the operational life thereof.

A sealing unit assembled by said V-ring seal (1) consists essentially of three plastic V-shaped annular frames (2) and two V-ring seals (1). Each seal (1) is inserted between two frames (2) and all five elements are stacked upwardly as a set of plunger seal assembly for coupling with a plunger of a pump.

While the invention has been illustrated and described, it is not intended to be limited to the detail shown, since various modifications and structural changes may be made without departing in any way from the spirit of the present invention.

What is claimed is:

1. A V-ring seal (1) consists essentially of:
An upper V-shaped recess (5), an inner wall (6), an exterior wall (7) and a V-shaped lower surface (9);
Said upper V-shaped recess (5) is formed by two annular bevels, each is disposed on an end of an upper portion of the seal;
Said inner wall (6) is an annular bevel whose one end adjoins with an end of an inner flank of said recess (5);
Said exterior wall (7) is an annular bevel whose one end adjoins with an end of a lateral flank of said recess (5);
Said V-shaped lower surface (9) is formed by two annular bevels, each is disposed on an end of a lower portion of the seal and one flank thereof attaches with another end of the inner wall (6) and exterior wall (7) respectively;
Said V-ring seal (1) is characterized in that: an annular groove (8) is disposed on a bottom of said upper recess (5) where two bevels intersect; a bottom of the groove (8) is in an open arc shape.

2. A V-ring seal (1) of claim 1, wherein said seal (1) has an integral structure of an annular shape and a sectional structure of a V-shape.

3. A V-ring seal (1) of claim 1, wherein said V-ring seal (1) is made of fabric reinforced rubber.

4. A V-ring seal (1) of claim 1, wherein said inner wall (6) adjoins with said upper recess (5) by a sharp edge or a transient curve.

5. A V-ring seal (1) of claim 1, wherein said exterior wall (7) adjoins with said upper recess (5) by a sharp edge or a transient curve.
